(19) United States
(12) Patent Application Publication
(10) Pub. No.: US 2024/0356004 A1
(43) Pub. Date: Oct. 24, 2024

(54) NEGATIVE ELECTRODE PLATE AND BATTERY INCLUDING THE NEGATIVE ELECTRODE PLATE

(71) Applicant: ZHUHAI COSMX BATTERY CO., LTD., Zhuhai (CN)

(72) Inventors: Dianyang HU, Zhuhai (CN); Suli LI, Zhuhai (CN)

(73) Assignee: ZHUHAI COSMX BATTERY CO., LTD., Zhuhai (CN)

(21) Appl. No.: 18/761,758

(22) Filed: Jul. 2, 2024

Related U.S. Application Data
(63) Continuation of application No. PCT/CN2022/138937, filed on Dec. 14, 2022.

(30) Foreign Application Priority Data
Jan. 7, 2022 (CN) 202210016118.8

(51) Int. Cl. H01M 4/133; H01M 4/02; H01M 4/36; H01M 4/587; H01M 4/62

(52) U.S. Cl. CPC H01M 4/133; H01M 4/366; H01M 4/587; H01M 4/622; H01M 4/625; H01M 2004/021; H01M 2004/027

(57) ABSTRACT

Disclosed are a negative electrode plate and a battery including the negative electrode plate. The negative electrode plate includes a current collector, a first active material layer, and a second active material layer, the first active material layer includes a first negative electrode active material, a length-to-diameter ratio of the first negative electrode active material ranges from 3 to 5, and the second active material layer includes a second negative electrode active material with a length-to-diameter ratio ranging from 1 to 2. An effective liquid-phase diffusion channel is constructed for lithium ions by using a combination of negative electrode active materials with different length-to-diameter ratios. This may significantly improve rate performance and energy density of a battery cell, and further resolve a problem of lithium deposition caused by a lower electric potential of the negative electrode plate near a surface of a separator.

### CROSS-REFERENCE TO RELATED APPLICATIONS

The present disclosure is a continuation of the International Application No. PCT/CN2022/138937, filed on Dec. 14, 2022, which claims priority to Chinese Patent Application No. 202210016118.8, filed on Jan. 7, 2022. All the foregoing applications are incorporated herein by reference in their entities.

### TECHNICAL FIELD

The present disclosure pertains to the field of secondary battery technologies, and specifically relates to a negative electrode plate and a battery including the negative electrode plate.

### BACKGROUND

Since the commercialization of batteries, batteries have been widely used in fields such as digital, energy storage, power, military aerospace, and communications devices due to their high specific energy and good cycling performance. With extensive application of lithium-ion batteries, consumers have increasing requirements for a use environment, a charging speed, and an endurance time of lithium-ion batteries, and also have increasingly high requirements for an endurance capacity of an electronic device. Therefore, it is required that both rate performance and energy density should be taken into consideration for lithium-ion batteries. However, as a charging speed increases, in a case of large rate charging, a problem such as lithium deposition easily occurs on a negative electrode.

### SUMMARY

To overcome a disadvantage of the prior art, the present disclosure provides a negative electrode plate and a battery including the negative electrode plate. The negative electrode plate may improve rate performance and energy density of the battery, and effectively resolve the following problem: in a case of an electrode plate design with a large rate and high energy density, utilization rate of a negative electrode plate is low and lithium deposition occurs on a surface due to polarization and uneven electrolyte concentration, which affects use of the battery.

An objective of the present disclosure is implemented by using the following technical solutions.

A negative electrode plate includes a current collector, a first active material layer, and a second active material layer, the first active material layer is disposed on a surface of at least one side of the current collector, and the second active material layer is disposed on a surface, away from the current collector, of the first active material layer; the first active material layer includes a first negative electrode active material, and a length-to-diameter ratio of the first negative electrode active material ranges from 3 to 5; and the second active material layer includes a second negative electrode active material, and a length-to-diameter ratio of the second negative electrode active material ranges from 1 to 2.

The present disclosure further provides a battery, where the battery includes the foregoing negative electrode plate.

The present disclosure has the following beneficial effects.

The present disclosure provides a negative electrode plate and a battery that includes the negative electrode plate. Use of the negative electrode plate improves cycling performance of the battery under a large rate condition. An effective liquid-phase diffusion channel is constructed for lithium ions by using a combination of negative electrode active materials with different length-to-diameter ratios. This may significantly improve rate performance and energy density of a battery cell, and further resolve a problem of lithium deposition caused by a lower electric potential of the negative electrode plate near a surface of a separator.

### BRIEF DESCRIPTION OF THE DRAWINGS

To describe the technical solutions in embodiments of the present disclosure or related technologies more clearly, the following briefly describes the accompanying drawings required for describing embodiments of the present disclosure or the related technologies. Apparently, the accompanying drawings in the following description are merely some embodiments of the present disclosure. A person of ordinary skill in the art may still derive other drawings from these accompanying drawings without creative efforts.

FIG. 1 is a schematic structural diagram of a graphite particle according to the present disclosure.

FIG. 2 is a schematic structural diagram of a negative electrode plate in a preferred solution of the present disclosure.

### DETAILED DESCRIPTION OF THE EMBODIMENTS

The following describes specific implementations of the present disclosure in detail. It should be understood that the specific implementations described herein are merely used to describe and explain the present disclosure, and are not intended to limit the present disclosure.

Unless otherwise defined, all scientific and technical terms used in the present disclosure have the same meanings as are generally understood by those skilled in the art of the present disclosure.

A first aspect of the present disclosure provides a negative electrode plate, where the negative electrode plate includes a current collector, a first active material layer, and a second active material layer, the first active material layer is disposed on a surface of at least one side of the current collector, and the second active material layer is disposed on a surface, away from the current collector, of the first active material layer.

The first active material layer includes a first negative electrode active material, and a length-to-diameter ratio of the first negative electrode active material ranges from 3 to 5.

The second active material layer includes a second negative electrode active material, and a length-to-diameter ratio of the second negative electrode active material ranges from 1 to 2.

In the negative electrode plate, an effective liquid-phase diffusion channel is constructed for lithium ions by using a combination of negative electrode active materials with different length-to-diameter ratios, improving cycling performance of the battery under a large rate condition. This may significantly improve rate performance and energy density of a battery cell, and may further resolve a problem of lithium deposition caused by a lower electric potential of the negative electrode plate near a surface of a separator.

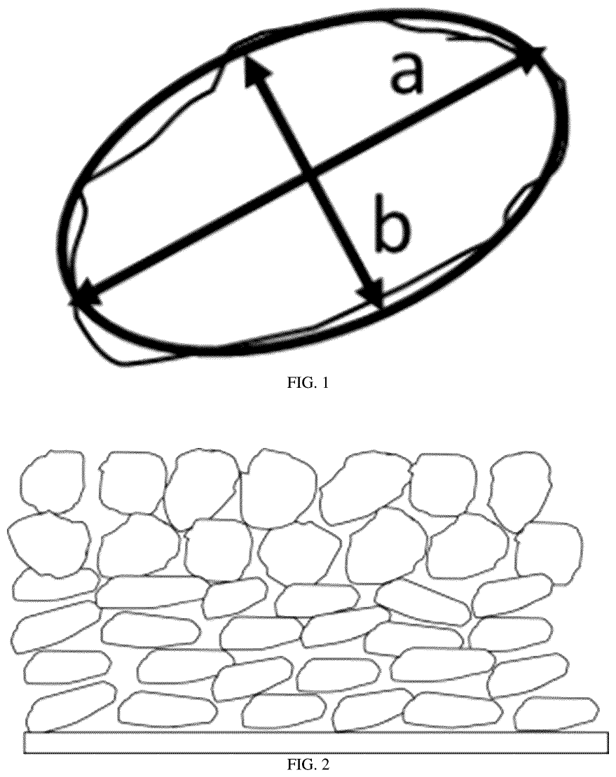

In the present disclosure, the length-to-diameter ratio refers to a ratio of a longest diameter (that is, a long axis of the negative electrode active material) a inside a negative electrode active material particle to a longest diameter b perpendicular to the longest diameter a. Specifically, as shown in FIG. 1, the length-to-diameter ratio may be obtained by using an image test software to characterize a SEM (Scanning Electronic Microscopy) cross section of the negative electrode active material particle.

According to an implementation of the present disclosure, the length-to-diameter ratio of the first negative electrode active material is 3, 3.5, 4, 4.5, or 5, and the first negative electrode active material has a relatively large length-to-diameter ratio (ranging from 3 to 5). Therefore, the first negative electrode active material is arranged in order in a roll-pressing process of producing the negative electrode plate, and a pore between negative electrode active material particles is relatively small. This may effectively improve space utilization of the electrode plate and improve energy density of a battery cell. When the length-to-diameter ratio is excessively large (greater than 5), the pore between negative electrode active material particles becomes larger, which prevents liquid-phase transmission of lithium ions. When the length-to-diameter ratio is excessively small (less than 3), the pore between negative electrode active material particles becomes larger, which obviously reduces space utilization of the electrode plate and does not obviously improve energy density.

According to an implementation of the present disclosure, the first active material layer is disposed on surfaces of both sides of the current collector, and the second active material layer is disposed on a surface, away from the current collector, of the first active material layer.

According to an implementation of the present disclosure, a long axis of the first negative electrode active material ranges from 5 μm to 15 μm, for example, 5 μm, 6 μm, 7 μm, 8 μm, 9 μm, 10 μm, 11 μm, 12 μm, 13 μm, 14 μm, 15 μm, or any point value within a range formed by every two of the foregoing point values.

When the long axis of the first negative electrode active material is excessively long (greater than 15 μm), rate performance of the battery deteriorates, resulting in lithium deposition. When the long axis of the first negative electrode active material is excessively short (less than 5 μm), energy density of the battery is not significantly improved.

According to an implementation of the present disclosure, a particle size (Dv50) of the first negative electrode active material ranges from 5 μm to 15 μm, for example, 5 μm, 6 μm, 7 μm, 8 μm, 9 μm, 10 μm, 11 μm, 12 μm, 13 μm, 14 μm, 15 μm, or any point value within a range formed by every two of the foregoing point values. The Dv50 may be tested by using a laser granulometer, and the Dv50 refers to a particle size corresponding to a sample whose cumulative volume particle size distribution percentage reaches 50%.

When the particle size Dv50 of the first negative electrode active material is within the foregoing range, a contact area between an electrode and lithium ions in electrolyte solution may be improved, thereby promoting rapid ion diffusion and improving cycling performance of the battery under a large rate condition.

According to an implementation of the present disclosure, the length-to-diameter ratio of the second negative electrode active material is 1, 1.5, or 2, and the second negative electrode active material has a relatively small length-to-diameter ratio (ranging from 1 to 2). Therefore, a liquid-phase diffusion channel may be added on the second active material layer for lithium ions, which improves utilization of the electrode plate. When the length-to-diameter ratio is excessively large (greater than 2), liquid-phase transmission of lithium ions is prevented. When the length-to-diameter ratio is excessively small (less than 1), space utilization of the electrode plate is not high, and an effect of improving energy density is not obvious.

According to an implementation of the present disclosure, a long axis of the second negative electrode active material ranges from 15 μm to 25 μm, for example, 15 μm, 16 μm, 17 μm, 18 μm, 19 μm, 20 μm, 21 μm, 22 μm, 23 μm, 24 μm, 25 μm, or any point value within a range formed by every two of the foregoing point values.

When the long axis of the second negative electrode active material is excessively long (greater than 25 μm), rate performance of the battery deteriorates, resulting in lithium deposition. When the long axis of the second negative electrode active material is excessively short (less than 15 μm), energy density of the battery is not significantly improved.

According to an implementation of the present disclosure, a particle size Dv50 of the second negative electrode active material ranges from 15 μm to 25 μm, for example, is 15 μm, 16 μm, 17 μm, 18 μm, 19 μm, 20 μm, 21 μm, 22 μm, 23 μm, 24 μm, 25 μm, or any point value within a range formed by every two of the foregoing point values. When the particle size Dv50 of the second negative electrode active material is within the foregoing range, the second negative electrode active material is used in combination with the first negative electrode active material. This can further promote rapid ion diffusion and further improve cycling performance of the battery under a large rate condition.

According to an implementation of the present disclosure, a ratio h2/h1 of a thickness h2 of the second active material layer to a thickness h1 of the first active material layer is 0.1≤h2/h1≤1. Research shows that when h2/h1 is 0.1≤h2/h1≤1, not only rate performance may be met, but also energy density of the electrode plate may be improved. When h2/h1 is greater than 1, the second negative electrode active material is plenty, that is, there is a large quantity of large particles, and rate performance of the electrode plate is poor. When h2/h1 is less than 0.1, the second negative electrode active material is little, that is, there is a small quantity of large particles, and improvement on a surface porosity of the electrode plate is limited.

According to an implementation of the present disclosure, the thickness h1 of the first active material layer ranges from 10 μm to 100 μm, for example, may be 10 μm, 20 μm, 30 μm, 40 μm, 50 μm, 60 μm, 70 μm, 80 μm, 90 μm, or 100 μm.

According to an implementation of the present disclosure, the thickness h2 of the second active material layer ranges from 10 μm to 100 μm, for example, may be 10 μm, 20 μm, 30 μm, 40 μm, 50 μm, 60 μm, 70 μm, 80 μm, 90 μm, or 100 μm.

When the thickness h1 of the first active material layer and the thickness h2 of the second active material layer are within the foregoing ranges, a thickness of a negative electrode active material layer is optimized. This may improve energy density of the battery and improve energy storage performance of the battery.

According to an implementation of the present disclosure, the first active material layer further includes a first conductive agent and a first binder.

According to an implementation of the present disclosure, the second active material layer further includes a second conductive agent and a second binder.

According to an implementation of the present disclosure, the first negative electrode active material and the second negative electrode active material are the same or different; and/or, the first conductive agent and the second conductive agent are the same or different; and/or, the first binder and the second binder are the same or different.

The first conductive agent and the second conductive agent are the same or different, and independently include at least one of conductive carbon black, acetylene black, Keqin black, conductive graphite, conductive carbon fiber, carbon nanotube, or metal powder.

The first binder and the second binder are the same or different, and independently include at least one of styrene-butadiene rubber (SBR), polyvinylidene fluoride (PVDF), polyacrylonitrile, polystyrene-acrylate, or polyacrylic acid ester.

The first negative electrode active material and the second negative electrode active material are the same or different, and independently include at least one of graphite, soft carbon, hard carbon, silicon, silicon oxide, silicon carbide, or silicon alloy.

According to an implementation of the present disclosure, a mass percentage of each component in the first active material layer is: 90 wt %-99 wt % first negative electrode active material, 0.5 wt %-10 wt % first conductive agent, and 0.5 wt %-10 wt % first binder.

Preferably, a mass percentage of each component in the first active material layer is as follows:

92 wt %-99 wt % first negative electrode active material, 0.5 wt %-4 wt % first conductive agent, and 0.5 wt %-4 wt % first binder.

According to an implementation of the present disclosure, a mass percentage of each component in the second active material layer is: 80 wt %-99 wt % second negative electrode active material, 0.5 wt %-10 wt % second conductive agent, and 0.5 wt %-10 wt % second binder.

Preferably, a mass percentage of each component in the second active material layer is as follows:

92 wt %-99 wt % second negative electrode active material, 0.5 wt %-4 wt % second conductive agent, and 0.5 wt %-4 wt % second binder.

A content ratio of the first negative electrode active material, the conductive agent, and the binder in the first active material layer is controlled, and a content ratio of the second negative electrode active material, the conductive agent, and the binder in the second active material layer is controlled, so that a structure of a negative electrode active material layer may be optimized, and a capacity and energy density of the battery may be improved.

Further, in the first active material layer and the second active material layer, when the content ratios of the negative electrode active material, the conductive agent, and the binder are within the foregoing ranges, it is conductive to increasing pore structures of the active material layers, promoting rapid ion diffusion, improving a charging and discharging rate of the battery, and further improving cycling performance of the battery under a large rate condition.

The present disclosure further provides a method for preparing the foregoing negative electrode plate. The method includes the following steps:
(1) preparing a slurry for forming a first active material layer and a slurry for forming a second active material layer respectively; and
(2) applying the slurry for forming the first active material layer and the slurry for forming the second active material layer on surfaces of both sides of a current collector by using a double-layer coating machine, to obtain the negative electrode plate.

According to an implementation of the present disclosure, in step (1), a solid content of the slurry for forming the first active material layer and that of the slurry for forming the second active material layer range from 30 wt % to 60 wt %.

According to an implementation of the present disclosure, in step (1), a viscosity of the slurry for forming the first active material layer and that of the slurry for forming the second active material layer range from 2000 mPa's to 7000 mPa·s.

The present disclosure further provides a battery, where the battery includes the foregoing negative electrode plate.

According to the present disclosure, the battery is a lithium-ion battery.

The following clearly describes the technical solutions in embodiments of the present disclosure with reference to the accompanying drawings in embodiments of the present disclosure. Apparently, the described embodiments are merely some but not all of embodiments of the present disclosure. All other embodiments obtained by a person of ordinary skill in the art based on embodiments of the present disclosure without creative efforts shall fall within the protection scope of the present disclosure.

Experimental methods used in the following examples are conventional methods, unless otherwise specified. Reagents, materials, and the like used in the following examples are all commercially available, unless otherwise specified.

In the description of the present disclosure, it should be noted that the terms “first”, “second”, or the like, are only used for descriptive purposes, and do not indicate or imply relative importance.

### Example 1

(1) A negative electrode slurry 1 was prepared by using first graphite (with a Dv50 of 9 μm) with a length-to-diameter ratio of 4 and a long axis of 12 μm as a negative electrode active material: A mixture of a mass ratio of 96.8% negative electrode active material, 1.2% conductive agent (conductive carbon black), and 2% binder (styrene-butadiene rubber) was mixed with water and then stirred to obtain an active material layer slurry with a viscosity ranging from 2000 mPa's to 5000 mPa's and a solid content ranging from 40% to 50%.

(2) A negative electrode slurry 2 was prepared by using second graphite (with a Dv50 of 16 μm) with a length-to-diameter ratio of 1.5 and a long axis of 18 μm as a negative electrode active material: A mixture of a mass ratio of 96.8% negative electrode active material, 1.2% conductive agent (conductive carbon black), and 2% binder (styrene-butadiene rubber) was mixed with water and then stirred to obtain an active material layer slurry with a viscosity ranging from 2000 mPa's to 5000 mPa's and a solid content ranging from 40% to 50%.

(3) Both the negative electrode slurry prepared in step (1) and the negative electrode slurry prepared in step (2) were applied on a current collector, where the negative electrode slurry 2 was carried on the negative electrode slurry 1, and the negative electrode slurry 1 was carried on the current collector. Coating on both sides of the current collector was completed in a same manner. In a negative electrode plate obtained after coating, drying, and roll-pressing, a thickness of a first negative electrode active material layer was 30 μm, and a thickness of a second negative electrode active material layer was 30 μm.

(4) A positive electrode active material (lithium cobaltate), a conductive agent (conductive carbon black), and a binder (PVDF) were mixed according to a mass ratio of 96:2.5:1.5, dispersed in N-methylpyrrolidone (NMP) and stirred evenly, to prepare a slurry with a viscosity ranging from 2000 mPa's to 7000 mPa's and a solid content ranging from 70% to 80%. The slurry was applied evenly on surfaces of both sides of an aluminum foil of a positive electrode current collector, and the aluminum foil was baked at a temperature ranging from 100° C. to 150° C. for 4 hours to 8 hours, to make a positive electrode plate.

(5) After being rolled and die-cut, the positive electrode plate and the negative electrode plate obtained in the foregoing steps were assembled into a jelly roll through winding. After passing a short-circuit test, the jelly roll was packaged by using an aluminum-plastic film and then baked in an oven for removing moisture until a moisture standard required by solution injection was reached, and then an electrolyte solution was injected. After aging for 24 hours to 48 hours, charging was completed for the first time by using a process of hot pressing and forming to obtain an activated battery.

### Examples 2 to 6 and Comparative Examples 1 to 4

Differences between Examples 2 to 6 and Comparative Examples 1 to 4 and Example 1 lie in that the length-to-diameter ratio, the long axis of the first graphite and the second graphite, and the thickness of the first active material layer and the second active material layer. Details are shown in Table 1.

### Comparative Example 5

Other operations were the same as those in Example 1. A difference lies in that the negative electrode plate is prepared as follows.

A negative electrode slurry was prepared by using graphite with a length-to-diameter ratio of 1.5 and a long axis of 18 μm as a negative electrode active material: A mixture of a mass ratio of 96.8% negative electrode active material, 1.2% conductive agent (conductive carbon black), and 2% binder (styrene-butadiene rubber) was mixed with water and then stirred to obtain an active material layer slurry with a viscosity ranging from 2000 mPa's to 5000 mPa's and a solid content ranging from 40% to 50%.

The foregoing prepared negative electrode slurry was applied on both sides of a current collector. In a negative electrode plate obtained after coating, drying, and roll-pressing, a thickness of a negative electrode active material layer was 60 μm.

### Comparative Example 6

Other operations were the same as those in Example 1. A difference lies in that the negative electrode plate is prepared as follows.

A negative electrode slurry was prepared by using graphite with a length-to-diameter ratio of 3 and a long axis of 12 μm as a negative electrode active material: A mixture of a mass ratio of 96.8% negative electrode active material, 1.2% conductive agent (conductive carbon black), and 2% binder (styrene-butadiene rubber) was mixed with water and then stirred to obtain an active material layer slurry with a viscosity ranging from 2000 mPa's to 5000 mPa's and a solid content ranging from 40% to 50%.

The foregoing prepared negative electrode slurry was applied on both sides of a current collector. In a negative electrode plate obtained after coating, drying, and roll-pressing, a thickness of a negative electrode active material layer was 60 μm.

### Performance Test:

A battery cell prepared in the foregoing examples and comparative examples was fully charged at 0.5 C, and a ratio of an energy E of discharging at 0.5 C to a volume V of the battery cell was an energy density ED (Wh·L⁻¹).

A life test was performed on the battery cell prepared in the foregoing examples and comparative examples for 700 cycles by using charging at 3 C and discharging at 1 C.

The battery cell prepared in the foregoing examples and comparative examples was fully charged at 5 C and discharged at 0.5 C. After being charged and discharged for 20 times, the battery cell was dissected to check a status of lithium deposition.

TABLE 1
Composition and performance test results of batteries in Examples and Comparative Examples

| | | | | | | | | 700T | |
|---|---|---|---|---|---|---|---|---|---|
| | Second graphite | | First graphite | | | | | cycling | |
| | Length-to- | Long | Length-to- | Long | | | | capacity | Status of |
| | diameter | axis | diameter | axis | h2 | h1 | ED | retention | lithium |
| | ratio | (μm) | ratio | (μm) | (μm) | (μm) | (Wh · L⁻¹⁾ | rate | deposition |
| Example 1-1 | 1.5 | 18 | 4 | 12 | 30 | 30 | 735 | 86.3% | No lithium |
| | | | | | | | | | deposition |
| Example 1-2 | 1.8 | 18 | 4 | 12 | 30 | 30 | 736 | 86.5% | No lithium |
| | | | | | | | | | deposition |
| Example 1-3 | 1.5 | 18 | 4.5 | 12 | 30 | 30 | 736 | 86.2% | No lithium |
| | | | | | | | | | deposition |
| Example 2 | 1 | 18 | 3 | 12 | 30 | 30 | 730 | 86.7% | No lithium |
| | | | | | | | | | deposition |
| Example 3 | 2 | 18 | 5 | 12 | 30 | 30 | 737 | 85.9% | No lithium |
| | | | | | | | | | deposition |
| Example 4 | 1.5 | 15 | 4 | 5 | 30 | 30 | 733 | 86.9% | No lithium |
| | | | | | | | | | deposition |
| Example 5 | 1.5 | 25 | 4 | 15 | 30 | 30 | 739 | 85.7% | lithium |
| | | | | | | | | | deposition |
| Example 6 | 1.5 | 18 | 4 | 12 | 20 | 40 | 730 | 87% | lithium |
| | | | | | | | | | deposition |
| Comparative | 3 | 18 | 6 | 12 | 30 | 30 | 722 | 78.3% | lithium |
| Example 1 | | | | | | | | | deposition |
| Comparative | 1.5 | 10 | 4 | 5 | 30 | 30 | 718 | 79.5% | lithium |
| Example 2 | | | | | | | | | deposition |
| Comparative | 1.5 | 30 | 4 | 20 | 30 | 30 | 725 | 75.3% | lithium |
| Example 3 | | | | | | | | | deposition |
| Comparative | 1.5 | 18 | 4 | 12 | 40 | 20 | 728 | 78.5% | lithium |
| Example 4 | | | | | | | | | deposition |
| Comparative | 1.5 | 18 | / | / | 60 | / | 712 | 76.5% | No lithium |
| Example 5 | | | | | | | | | deposition |
| Comparative | / | / | 4 | 12 | / | 60 | 708 | 78.6% | No lithium |
| Example 6 | | | | | | | | | deposition |
| Comparative | 1.5 | 18 | 2.5 | 12 | 30 | 30 | 721 | 79.1% | lithium |
| Example 7 | | | | | | | | | deposition |

The results of the foregoing examples and comparative examples show that, compared with conventional manners in Comparative Examples 5 and 6, Examples 1 to 6 prepared according to the present disclosure resolve problems of lithium deposition and a cycling capacity retention rate of a battery cell.

### Example Group 7

A battery was prepared with reference to Example 1. A difference lies in that values of the Dv50 of the first graphite and the second graphite are respectively different from those of the battery in Example 1.

Example 7a: The Dv50 of the first graphite was 5 μm, and the Dv50 of the second graphite was 15 μm.

Example 7b: The Dv50 of the first graphite was 15 μm, and the Dv50 of the second graphite was 25 μm.

Example 7c: The Dv50 of the first graphite was 3 μm, and the Dv50 of the second graphite was 10 μm.

TABLE 2

| | | 700 T cycling | |
|---|---|---|---|
| | ED/ | capacity | Status of lithium |
| | Wh · L⁻¹ | retention rate | deposition |
| Example 7a | 730 | 86.9% | No lithium deposition |
| Example 7b | 738 | 86.1% | No lithium deposition |
| Example 7c | 715 | 86.3% | No lithium deposition |

Embodiments in this specification are described in a related manner, the same or similar parts between embodiments may refer to each other, and each embodiment focuses on differences from other embodiments. The foregoing descriptions are merely preferred embodiments of the present disclosure, rather than limiting the protection scope of the present disclosure. Any modification, equivalent replacement, or improvement made without departing from the spirit and principle of the present disclosure shall fall within the protection scope of the present disclosure.

What is claimed is:

1. A negative electrode plate, comprising a current collector, a first active material layer, and a second active material layer, wherein
the first active material layer is disposed on a surface of at least one side of the current collector, and the second active material layer is disposed on a surface of the first active material layer;
the first active material layer comprises a first negative electrode active material, and a length-to-diameter ratio of the first negative electrode active material ranges from 3 to 5; and
the second active material layer comprises a second negative electrode active material, and a length-to-diameter ratio of the second negative electrode active material ranges from 1 to 2.

2. The negative electrode plate according to claim 1, wherein a long axis of the first negative electrode active material ranges from 5 μm to 15 μm.

3. The negative electrode plate according to claim 1, wherein a long axis of the second negative electrode active material ranges from 15 μm to 25 μm.

4. The negative electrode plate according to claim 1, wherein a particle size (Dv50) of the first negative electrode active material ranges from 5 μm to 15 μm.

5. The negative electrode plate according to claim 1, wherein a particle size (Dv50) of the second negative electrode active material ranges from 15 μm to 25 μm.

6. The negative electrode plate according to claim 1, wherein a ratio h2/h1 of a thickness h2 of the second active material layer to a thickness h1 of the first active material layer is 0.1≤h2/h1≤1.

7. The negative electrode plate according to claim 6, wherein a thickness h1 of the first active material layer ranges from 10 μm to 100 μm.

8. The negative electrode plate according to claim 6, wherein a thickness h2 of the second active material layer ranges from 10 μm to 100 μm.

9. The negative electrode plate according to claim 1, wherein the first active material layer further comprises a first conductive agent and a first binder; and/or
the second active material layer further comprises a second conductive agent and a second binder.

10. The negative electrode plate according to claim 9, wherein a mass percentage of each component in the first active material layer is: 90 wt %-99 wt % first negative electrode active material, 0.5 wt %-10 wt % first conductive agent, and 0.5 wt %-10 wt % first binder.

11. The negative electrode plate according to claim 10, wherein a mass percentage of each component in the first active material layer is: 92 wt %-99 wt % first negative electrode active material, 0.5 wt %-4 wt % first conductive agent, and 0.5 wt %-4 wt % first binder.

12. The negative electrode plate according to claim 9, wherein a mass percentage of each component in the second active material layer is: 80 wt %-99 wt % second negative electrode active material, 0.5 wt %-10 wt % second conductive agent, and 0.5 wt %-10 wt % second binder.

13. The negative electrode plate according to claim 12, wherein a mass percentage of each component in the second active material layer is: 92 wt %-99 wt % second negative electrode active material, 0.5 wt %-4 wt % second conductive agent, and 0.5 wt %-4 wt % second binder.

14. The negative electrode plate according to claim 1, wherein the first negative electrode active material and the second negative electrode active material are the same or different, and independently comprise at least one of graphite, soft carbon, hard carbon, silicon, silicon oxide, silicon carbide, or silicon alloy.

15. The negative electrode plate according to claim 9, wherein the first conductive agent and the second conductive agent are the same or different, and independently comprise at least one of conductive carbon black, acetylene black, Keqin black, conductive graphite, conductive carbon fiber, carbon nanotube, or metal powder.

16. The negative electrode plate according to claim 9, wherein the first binder and the second binder are the same or different, and independently comprise at least one of styrene-butadiene rubber, polyvinylidene fluoride, polyacrylonitrile, polystyrene-acrylate, or polyacrylic acid ester.

17. A battery, comprising the negative electrode plate according to claim 1.
